(19) United States
(12) Patent Application Publication
(10) Pub. No.: US 2019/0171265 A1
(43) Pub. Date: Jun. 6, 2019

(54) POWER INPUT MODULE

(71) Applicant: HEWLETT PACKARD ENTERPRISE DEVELOPMENT LP, Houston, TX (US)

(72) Inventors: Mark Rivera, Houston, TX (US); Stephen Airey, Houston, TX (US); David Mohr, Houston, TX (US); Daniel Humphrey, Houston, TX (US)

(21) Appl. No.: 15/832,115

(22) Filed: Dec. 5, 2017

(51) Int. Cl. G06F 1/26; G06F 1/32; G06F 1/30; H02J 9/06

(52) U.S. Cl. CPC G06F 1/263; H02J 9/061; G06F 1/30; G06F 1/3206

(57) ABSTRACT

An example module may include a first input power connector and a second input power connector; an input power line transfer switch circuit to connect one of the first input power connector and the second input power connector to an output power connector based on a power event; and an energy storage component to connect to a hot plug output power connector.

### BACKGROUND

Cost considerations are a main factor when purchasing servers. However, other factors, such as redundancy, availability, and serviceability may be taken into account. Typically, a server includes slots for redundant power supplies.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figure:

FIG. 1 is a block diagram of an example module including input power connectors, an output power connector, an input power line transfer switch circuit, an energy storage component, and a hot plug output power connector;

FIG. 2 is a block diagram of an example of input power connectors, an output power connector, and an input power line transfer switch circuit of an example module;

FIG. 3 is a block diagram of an example system including a module and a power supply; and

FIG. 4 is a flowchart of an example method of a module for switching between input power connectors based on power events.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Cost considerations are a main factor when purchasing servers. However, other factors, such as redundancy, availability, and serviceability may be taken into account. Typically, a server includes slots for redundant power supplies.

Examples described herein may utilize a module to replace a power supply at a lower cost, while continuing to offer redundancy, availability, and serviceability. The module may include input power connectors that receive power from input power cables. The input power cables may connect to either different or the same power distribution units. The module may also include an input power line transfer switch circuit. The input power line transfer switch circuit may toggle between input power connectors based on power events. The power event may include input power degradation, input power failure, load balancing, over loading, or other issues. The module may also include an energy storage component. In the event of a power failure, the input power line transfer switch circuit may take an amount of time to switch to the other input cable. The energy storage component could power a system for that amount of time or even longer, in the event of a failed power supply. The energy storage component may connect to a hot plug output power connector of a system. The hot plug output power connector may connect to a systems power bus or rails, management bus, a backplane, or a midplane. Stated another way, the modules energy storage component may connect to the same connector as any other power supply of the system. Based on the components of the module described above, the module may be less costly than a normal power supply while continuing to offer redundancy, availability, and serviceability in the case of a power failure or power degradation.

For example, a module may include a first input power connector and a second input power connector. The module may also include an input power line transfer switch circuit. The input power line transfer switch circuit may connect either one of the first input power connector or the second input power connector to an output power connector, based on a power event. The module may also include an energy storage component to connect to a hot plug output power connector.

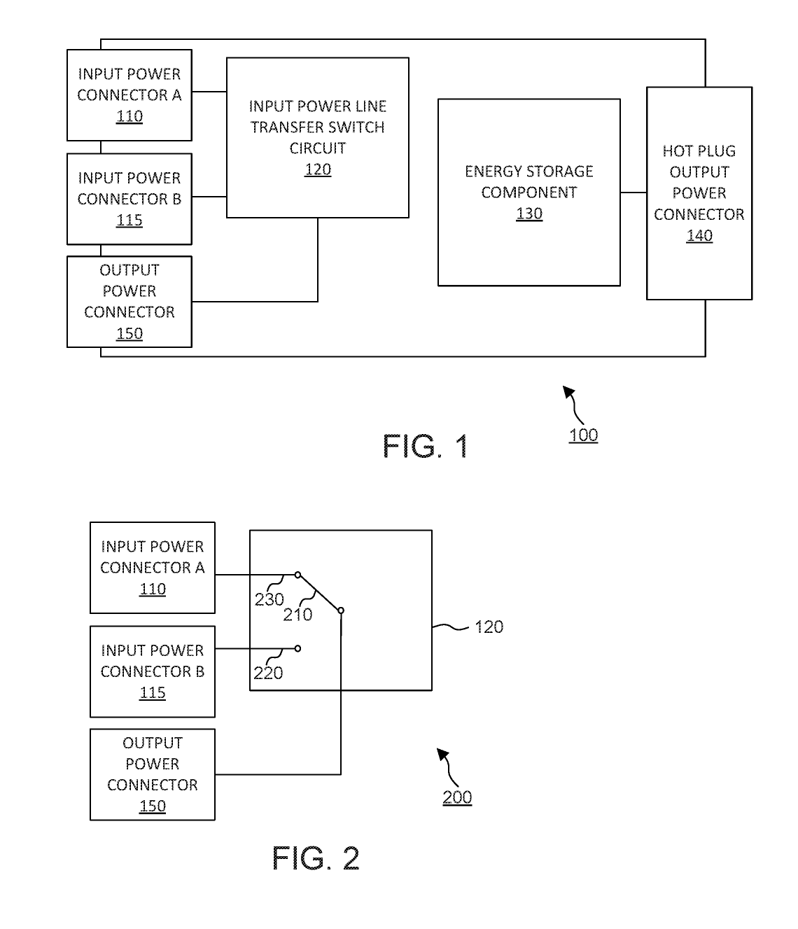

FIG. 1 is a block diagram of an example module 100 including input power connectors 110, 115, an output power connector 150, an input power line transfer switch circuit 120, an energy storage component 130, and a hot plug output power connector 140. The module 100 may include a first input power connector, such as input power connector A 110, and a second input power connector, such as input power connector B 115. The first input power connector (e.g., input power connector A 110) may connect to a first input power cable from a power distribution unit and the second input power connector (e.g., input power connector B 115) may connect to a second input power cable from either a different power distribution unit or the same power distribution unit. The first input power connector, input power connector A 110, and second input power connector, input power connector B 115, may connect to an input power line transfer switch circuit 120. The input power line transfer switch circuit 120 may connect to an output power connector 150 to provide power to a power supply. The input power line transfer switch circuit 120 may initially connect the first input power connector, input power connector A 110, to the output power connector 150. In other words, the first input power connector, input power connector A 110, may provide power to the output power connector 150 to provide power to a power supply. In response to a power event, the input power line transfer switch circuit 120 may switch the connection from one input power connector to the other input power connector (e.g., from input power connector A 110 to input power connector B 115). Stated another way, the input power line transfer switch circuit 120 may switch the input power connector providing power to the output power connector 150 from input power connector A 110 to input power connector B 115.

As used herein, a “system” may be a computing device, storage array, storage device, storage enclosure, server, desktop or laptop computer, computer cluster, node, partition, virtual machine, or any other device or equipment including a controller, a processor, or the like. As used herein, a “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution instructions stored on a machine-readable storage medium, or a combination thereof.

As used herein “backplane” or “midplane” may be a pre-routed printed circuit board disposed in a system. The backplane or midplane may include connections for various components. In an example, the backplane or midplane may include sockets or connections for power supplies on one side and connections to a motherboard or other components of a system. In such examples, the backplane or midplane may include power rails that transfer power to the system from a power supply.

As noted above, FIG. 1 shows a module 100 including an energy storage component 130. The energy storage component 130 may connect to a hot plug output power connector 140. In an example, the energy storage component 130 may be a battery, capacitor, super capacitor, or some combination thereof. Other energy storage components may be utilized as the energy storage component 130 of the module 100.

In another example, the module 100 may have the same dimensions as a power supply of a system. In such examples, a power supply and the module 100 may be interchangeable. In another example, the module 100 may be smaller than a power supply. In such examples, the receptacle for receiving the modules 100 and power supplies may be configurable to receive a number of modules 100 and a number of power supplies. In other words, the receptacle to receive power supplies may be dynamically configured to support any configuration, such as one module 100 and two power supplies or three modules 100 and three power supplies. In other examples, the receptacle to receive the module 100 may be in a different location than the power supplies. In a further example, the receptacle to receive the module 100 may be situated next to the receptacle to receive power supplies. The modules 100 hot plug output power connector 140 may connect to a systems normal power supply connections or socket. In other words, a system may include a receptacle or cage to receive a power supply. The receptacle to receive power supplies may include a backplane or midplane at the back of the receptacle or some other connection to connect power supplies to a power and control bus. The backplane or midplane may include sockets or female connectors for power supplies. The modules 100 hot plug output power connector may include a series of pins or male connectors to mate with a socket or female connector, respectively, of the backplane or midplane or some other connection to connect power supplies to a power and control bus. The systems power supply connectors may contain pins to receive and deliver power, as well as send and receive command or control signals. In such examples, the energy storage component 130 of the module 100 may deliver and receive (in other words, charge) power to and from the system. In other words, the module 100 may provide power to the system in the case of a power event and the module 100 may receive power to charge the energy storage component 130 during normal operation of the system or during some operation deemed sufficient to handle charging. The systems power supply connectors may include pins for management signals. The system may send management signals over a system management bus. The management signals may contain information or commands such as temperature measurement, charging signals, discharging signals, signals to indicate to the energy storage component 130 to provide power to the system, battery life left, battery age, capacitor life left, capacitor age, or other information and commands. The module 100 may include pins to send and receive the management signals.

In another example, the module 100 may hot plug or hot swap into a system. In other words, while a system is powered on the module 100 may be inserted into the system. In such examples, a module 100 may be replaced with another module 100 while the system is running. The module 100 may be added to the system while the system is powered off as well. In another example, during operation of the module 100 a power supply may be added or replaced with or without the system being powered on.

In an example, the module 100 may include multiple input power line transfer switch circuits 120. In such examples, each input power cable wire may correspond to an input power line transfer switch circuit 120. In an example, the input power line transfer switch circuit 120 may include digital devices, electro-mechanical devices, or a combination thereof. In such examples, the input power line transfer switch circuit 120 may monitor the current or voltage of the input power connectors 110, 115. In the instance that an active input power connectors 110, 115 voltage or current drops below a certain threshold, the input power line transfer switch circuit 120 may switch to the other input power connector 110, 115. The input power line transfer switch circuit 120 may also monitor the input power connectors 110, 115 for complete power failure and other issues.

FIG. 2 is a block diagram of an example of input power connectors 110, 115, an output power connector 150, and an input power line transfer switch circuit 120 of an example module. In an example, the input power line transfer switch circuit 120 is a switch 210 (for instance, an electro-mechanical switch). The switch 210 may select between input power connector A 110 and input power connector B 115. In other words, the switch 210 may determine which input power connecter 110, 115 may provide power to the output power connector 150 and thus provide power to a power supply. As describe above, the input power line transfer switch circuit 120 may include digital devices, electro-mechanical devices or a combination of both. For example, in the case that input power connector A 110 may be selected, digital devices may monitor the output on wire 230. If the output on wire 230 drops below a certain threshold or loses power completely then switch 210 will select the other input power connector (e.g., input power connector B 115) and the digital devices included in the input power line transfer switch circuit 120 may monitor wire 220. As described above, the module 100 may include multiple input power line transfer switch circuits 120. In such examples, one input power line transfer switch circuit 120 may monitor one set of wires (for instance, wires 220 and 230). If an active wire suffers from power degradation or power loss, the input power line transfer switch circuit 120, may switch over all input power line transfer switch circuits to another input power connector.

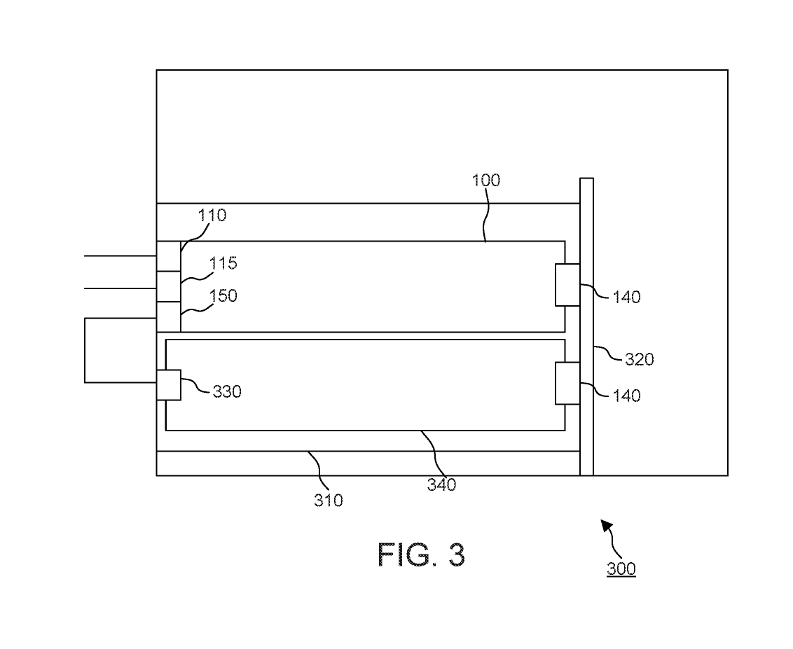

FIG. 3 is a block diagram of an example system 300 including a module 100 and a power supply 340. In an example, the system 300 may include a cage, bay, or receptacle 310 for power supplies 340. In a further example, the dimensions of a module 100 may be the same or similar to a power supply 340 and may include the same hot plug output power connector 140 as a power supply 340. In another example, the module 100 may hot plug or hot swap into the receptacle 310. The module 100, as described above, may include a first input power connector (e.g., input power connector A 110), a second input power connector (e.g., input power connector B 115), and an input power line transfer switch circuit. The system 300 may include a power and control bus 320 which power supplies 340 and modules 100 may connect to. The energy storage component of the module 100 may connect to the power and control bus 320 through the hot plug output power connector 140.

As noted above, the energy storage component may be a battery. The energy storage component may also be a capacitor or a combination of battery and capacitor. In such examples, the energy storage component may provide power to the system 300 for durations similar to the amount of time to replace components such as power supplies 340. In another example, the energy storage component may provide enough power to the system 300 during the time it takes for an input power connector 110, 115 to power on or provide power. In other examples, the energy storage components may provide at least enough power to allow for the input power line transfer switch circuit to switch between input power connectors 110, 115 in the case of a power line switchover event. A power line switchover event may include power degradation of an input power connector 110, 115, power loss at an input power connector 110, 115, a power surge at an input power connecter 110, 115, or similar power related issues.

In another example, a system similar to system 300 may include multiple power supplies (for instance, similar to power supply 340) and multiple modules 100. In another example, the modules may include more input power connectors 110, 115. For example, a system may include three power supplies 340 and one module 100. In such examples, the module 100 may include multiple input power connectors 110, 115 and multiple output power connectors 330. Further, multiple input power cables may connect to the module 100. Also, each output power connector 150 may connect with one of the plurality of power supplies 340.

In another example and as described above, the module 100 may be smaller than the power supply 340. In such an example, the module 100 may be small enough to fit equal to or greater than two modules 100 in a slot or receptacle normally meant for one power supply 340. In another example, the module 100 may include indicators, such as light emitting diodes (LEDs), for components of the module 100. For instance, the module may include an indicator per input power connector, an indicator per energy storage component, an indicator per output power connector, an indicator per input power line transfer switch circuit, or a combination thereof. The indicator may signal component status. For instance an LED emitting a green light may indicate a good operational status, while an LED emitting a yellow or red light may indicate an error or failure.

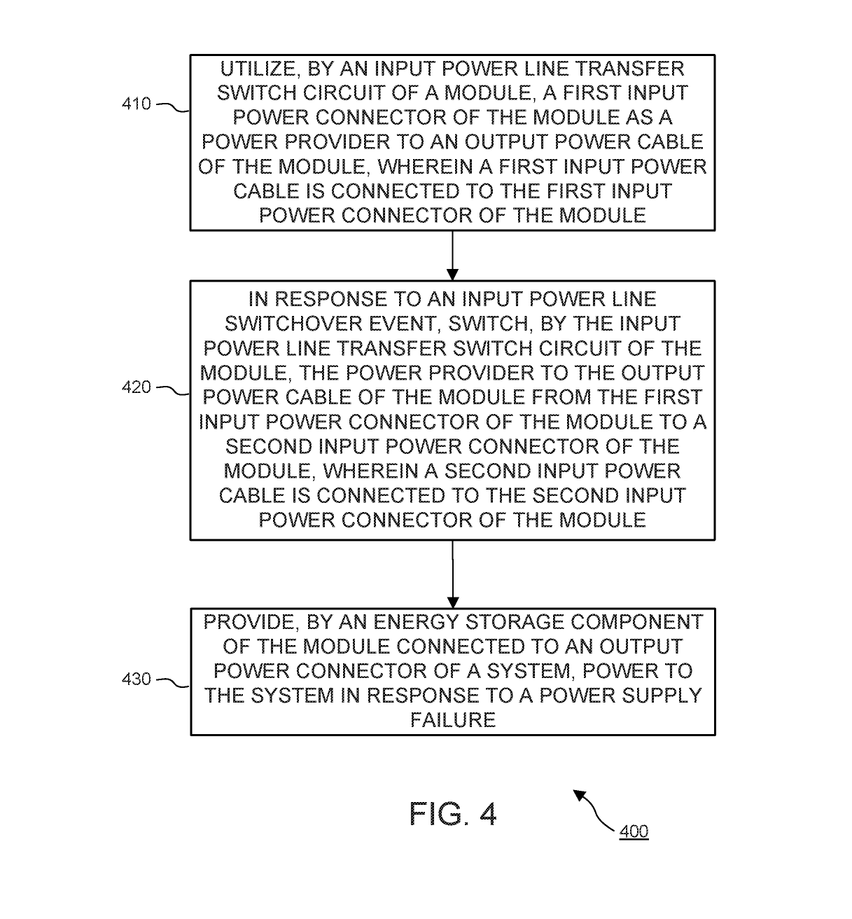

FIG. 4 is a flowchart of an example method of a module for switching between input power connectors based on power events. Although execution of method 400 is described below with reference to the module of FIG. 1, other suitable systems or modules may be utilized. Additionally, implementation of method 200 is not limited to such examples.

At block 410, a first input power connector (for example, input power connector A 110) is utilized as a power provider to an output power cable of module 100. A first input power cable may provide power to the first input power connector (e.g., input power connector A 110). Power may be transferred from the input power connector (e.g., input power connector A 110) to an output power cable through an input power line transfer switch circuit 120 of the module 100. In an example, the first input power cable may provide AC power. In another example, the first input power cable may provide DC power. In another example, the input power cable is a standard 3 pronged power cable. In other examples, different power cables may be utilized. In another example, connections other than a power cable may be utilized for an output power connection, such as a latch, pins, or through a connection internal to a system.

At block 420, in response to an input power line switchover event, the input power line transfer switch circuit 120 may switch the power provider to the output power cable from the first input power connector (e.g., input power connector A 110) to the second input power connector (e.g., input power connector B 115). A second input power cable may connect to the second input power connector (e.g., input power connector B 115). In an example, the second input power cable is from a different power distribution unit than the first input power cable. In another example, the second power cable may provide power of a different type than the first input power cable.

As stated above the power line transfer switch circuit 120 may switch the power provider of the output power cable, in response to a power line switchover event. In an example, the power line switchover event may be a power failure. For example, the first input power cable or the first input power connector (e.g., input power connector A 110) may stop providing power (as in, a power failure). In such examples, the input power line transfer switch circuit 120 of the module 100 may switch the power provider from the first input power connector (e.g., input power connector A 110) to the second input power connector (e.g., input power connector B 115). In another example, the power line switchover event may include power degradation. In another example, multiple input power connectors may be disposed in the module 100 and connect to multiple input power cables. In such examples, upon failure of one of the input power connectors the input power line transfer switch circuit 120 may switch to the next functioning input power connector.

At block 430, in response to a power supply failure, the energy storage component 130 may supply power to the system. If a power supply of the system fails, the energy storage component 130 may supply power to the system for a short period of time. In an example, the period of time may be at least long enough to allow a user to replace the failed power supply or for the system to backup data. In an example, the energy storage component 130 of the module 100 may connect to the same connector as a normal power supply. In such examples, the energy storage component 130 may provide power through the power supply connection (also known as the hot plug output power connector 140) during a power event, as well as charge through the power supply connection (e.g., the hot plug output power connector 140) during normal system operations. In a further example, the system may control the energy storage component 130 through the control pins of the power supply connection (e.g., the hot plug output power connector 140). For example, pins on the power supply connection (e.g., the hot plug output power connector 140) may connect to a baseboard management controller, a microcontroller, or some other control circuit or processor. The control circuit may send and receive signals via the control pins. The control circuit may control and monitor various aspects of the energy storage component 130, such as discharge rate, charge rate, and temperature. In another example, the energy storage component 130 may supply power to the system in the case of a power line switchover event. For example, in the case of a power line switchover event, the system may not receive power for a short period of time (for instance, on the order of milliseconds). For that short period of time (e.g., milliseconds) while the input power line transfer switch circuit 120 switches between input power connectors 110, 115, the energy storage component 130 may provide power to the system.

As used herein, a “baseboard management controller” or “BMC” is a specialized service processor that monitors the physical state of a server or other hardware using sensors and communicates with a management system through an independent “out-of-band” connection. The BMC may also communicate with applications executing at the OS level through the IOCTL interface driver. The BMC may have hardware level access to hardware devices located in a server chassis. The BMC may be able to directly modify the hardware devices. The BMC may be located on the motherboard or main circuit board of the server or other device to be monitored. The fact that a BMC is mounted on a motherboard of the managed server or otherwise connected or attached to the managed server does not prevent the BMC from being considered “separate”. As used herein, a BMC has management capabilities for sub-systems of a computing device, and is separate from a processing resource that executes an OS of a computing.

As noted above, the first input power cable and the second input power cable may come from separate power distribution units. In another example, the first input power cable and the second input power cable may come from the same power distribution units. In another example the first input power cable may provide AC power while the second input power cable provides DC power. In another example, there are multiple input power connectors and multiple input power cables. In such examples, the multiple input power cables may vary the power provided.

As noted above, the input power line transfer switch circuit 120 may connect to an output power cable. In another example, the input power line transfer switch circuit 120 may connect to pins or prongs that connect to an adjacent power supply when the power supply may be inserted into a server. In another example, the input power line transfer switch circuit 120 may connect to an output power latch or some other rigid power connector.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be examples. Structure and acts described herein are replaceable by equivalents, which perform the same function, even if the structure or acts are different, as known in the art. Therefore, the scope of the present disclosure is limited only by the elements and limitations as used in the claims

What is claimed is:

1. A module comprising:
a first input power connector and a second input power connector;
an input power line transfer switch circuit to connect one of the first input power connector and the second input power connector to an output power connector based on a power event; and
an energy storage component to connect to a hot plug output power connector.

2. The module of claim 1, wherein the module has the same dimensions as a power supply unit.

3. The module of claim 1, wherein the module is hot pluggable.

4. The module of claim 1, wherein the input power line transfer switch circuit toggles between the first input power connector and second input power connector based on the power event.

5. The module of claim 4, wherein the power event is input power degradation.

6. The module of claim 4, wherein the power event is input power failure.

7. The module of claim 1, wherein a first input power cable provides power to the first input power connector and a second input power cable provides power to the second input power connector.

8. A method comprising:
utilizing, by an input power line transfer switch circuit of a module, a first input power connector of the module as a power provider to an output power cable of the module, wherein a first input power cable is connected to the first input power connector of the module;
in response to an input power line switchover event, switching, by the input power line transfer switch circuit of the module, the power provider to the output power cable of the module from the first input power connector of the module to a second input power connector of the module, wherein a second input power cable is connected to the second input power connector of the module; and
providing, by an energy storage component of the module connected to an output power connector of a system, power to the system in response to a power supply failure.

9. The method of claim 8, wherein the output power cable is connected to a power supply unit.

10. The method of claim 8, wherein the first input power cable and second input power cable are connected to separate power distribution units.

11. The method of claim 8, wherein the input power line switchover event is input power degradation.

12. The method of claim 8, wherein the first input power cable provides AC power and second input power cable provides DC power.

13. A system comprising:
at least two bays to accept power supply units; and
a hot pluggable redundant power input module pluggable into the bays, the hot pluggable redundant power input module comprising:
a first input power connector and a second input power connector;
an input power line transfer switch circuit to connect one of the first input power connector and the second input power connector to an output power connector based on a power event;
an energy storage component to connect to a hot plug output power connector.

14. The system of claim 13, wherein the energy storage component is a battery.

15. The system of claim 13, wherein the energy storage component is a capacitor.

16. The system of claim 13, wherein the energy storage component is a combination of a battery and a capacitor.

17. The system of claim 13, wherein a power supply unit is inserted adjacent to the hot pluggable redundant power input module.

18. The system of claim 13, wherein the energy storage component provides power to the system in response to a switchover power event.

19. The system of claim 13, wherein the energy storage component is charged by the system through the hot plug output power connector.

20. The system of claim 13, wherein the energy storage component is controlled by a processor of the system.
